(19) United States
(12) Patent Application Publication
(10) Pub. No.: US 2023/0274468 A1
(43) Pub. Date: Aug. 31, 2023

(54) SYSTEMS AND METHODS FOR ANALYZING WORKSPACE CLUTTER AND GENERATING IMPROVED WORKSPACE LAYOUTS

(71) Applicant: SIGNIFY HOLDING B.V., EINDHOVEN (NL)

(72) Inventors: JASLEEN KAUR, MELROSE, MA (US); DAKSHA YADAV, BOSTON, MA (US); SHAHIN MAHDIZADEHAGHDAM, MILPITAS, CA (US); ARHUM SAVERA, CAMBRIDGE, MA (US)

(21) Appl. No.: 18/008,205

(22) PCT Filed: May 28, 2021
(86) PCT No.: PCT/EP2021/064316

§ 371 Date: Dec. 5, 2022

Related U.S. Application Data
(60) Provisional application No. 63/034,586, filed on Jun. 4, 2020.

(30) Foreign Application Priority Data
Jun. 11, 2020 (EP) 20179511.9

(51) Int. Cl. G06T 11/00; G01V 8/10; G01V 9/00

(52) U.S. Cl. CPC G06T 11/00; G01V 8/10; G01V 9/005; G06T 2200/24

(57) ABSTRACT

A system for evaluating a workspace surface having one or more objects placed thereon is disclosed. The system may include sensors configured to capture data corresponding to the workspace surface and a controller communicatively coupled to the sensors. The controller may generate an illuminance map of the workspace surface based on the captured data. The controller may generate a clutter entropy level based on the illuminance map and an entropy assessor. The controller may determine whether the clutter entropy level exceeds a clutter threshold. The controller may provide a clutter indication to a user device if the clutter entropy level exceeds the clutter threshold. The controller may identify the objects placed on the workspace surface. The controller may generate a decluttered layout based on the one or more objects and a layout generator.

### FIELD OF THE DISCLOSURE

The present disclosure is directed generally to analyzing workspace clutter and generating improved layouts of the objects found in the workspace.

### BACKGROUND

Desk organization is directly related to productivity. In the office environment, desk organization is necessary to prevent losing important items. Further, a cluttered desk may be a sign of poor organization which can impact the performance of an employee. Retrieval time for relevant documents can take up valuable time due to poor organization layout. Poor organizational layout of items can also affect the day-to-day productivity of workers.

Workspace occupants can reduce the time to organize their desk or workspace if they are given feedback in a timely manner. Providing these occupants with optimal or even improved layouts for their desk space can drastically minimize the time required to arrange workspace objects. Further, providing improved layouts can motivate the occupants to organize their workspaces. Accordingly, there is a need for (1) analyzing workspace desk clutter and (2) generating improved layouts of the objects found in the workspace.

Panos E Tranhanas et. al. ‘Visual Recognition of Workspace Landmarks for Topological Navigation’ discloses a robot navigation method which is approached using visual landmarks. Landmarks are not preselected or otherwise defined a priori; they are extracted automatically during a learning phase. To facilitate this, a saliency map is constructed on the basis of which potential landmarks are highlighted. This is used in conjunction with a model-driven segregation of the workspace to further delineate search areas for landmarks in the environment.

### SUMMARY OF THE DISCLOSURE

This present disclosure is directed to systems and methods for evaluating workspace surface clutter and generating improved workspace layouts. The system utilizes one or more sensors, such as thermopiles or spectrometers, to capture data and generate an illuminance map representing the current layout of objects on a user's workspace (such as a desk or table). The system then generates a clutter entropy level for the illuminance map. If the clutter entropy level exceeds a clutter threshold, the system provides the user with an indication that their workspace is too cluttered. The system may then generate, and provide to the user, decluttered layouts in which the objects are rearranged to reduce clutter.

Generally, in one aspect, a system for evaluating a workspace surface is disclosed. One or more objects may be placed on the workspace surface. The system may include one or more sensors. The sensors may be configured to capture data corresponding to the workspace surface. At least one of the one or more sensors may be a thermopile or a spectrometer.

The system may include a controller communicatively coupled to the one or more sensors. The controller may be configured to generate an illuminance map of the workspace surface. The illuminance map may be based on the captured data. The illuminance map may be generated in grayscale.

The controller may be configured to generate a clutter entropy level. The clutter entropy level may be based on the illuminance map and an entropy assessor.

The controller may be configured to determine whether the clutter entropy level exceeds a clutter threshold. The controller may be configured to provide a clutter indication to a user device if the clutter entropy level exceeds the clutter threshold. The user device may include a user interface configured to display the clutter entropy level.

The controller may be further configured to identify one or more of the objects placed on the workspace surface corresponding to at least a portion of the illuminance map. The controller may be further configured to generate a decluttered layout based on the one or more objects and a layout generator. The decluttered layout may include proposed new locations for the one or more objects placed on the workspace surface. The controller may be further configured to provide the decluttered layout to the user device.

According to an example, the user device may include a user interface configured to display the decluttered layout. Further, the user device may include a user interface configured to receive user feedback regarding the decluttered layout.

According to an example, the controller may be further configured to update the clutter threshold based on the user feedback and a threshold adjuster.

According to an example, the controller may be further configured to update the clutter threshold based on the captured data corresponding to the workspace surface and a threshold adjuster. The controller may be further configured to update the layout generator based on the captured data corresponding to the workspace surface.

Generally, in another aspect, a method for evaluating a workspace surface having one or more objects placed thereon is disclosed. The method may include capturing, via one or more sensors, data corresponding to the workspace surface. The method may further include generating an illuminance map of the workspace surface based on the captured data. The method may further include generating a clutter entropy level based on the illuminance map and an entropy assessor. The method may further include determining whether the clutter entropy level exceeds a clutter threshold. The method may further include providing a clutter indication to a user device if the clutter entropy level exceeds the clutter threshold. The method may further include displaying, via a user interface of the user device, the clutter entropy level.

According to an example, the method may further include identifying one or more objects placed on the workspace surface corresponding to at least a portion of the illuminance map. The method may further include generating a decluttered layout based on the one or more objects and a layout generator, the decluttered layout including proposed new locations for the one or more objects placed on the workspace surface. The method may further include providing the decluttered layout to the user device. The method may further include displaying, via a user interface of the user device, the decluttered layout.

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic of a system for analyzing workspace desk clutter and generating improved layouts, in accordance with an example.

FIG. 2 is a further schematic of a system for analyzing workspace desk clutter and generating improved layouts, in accordance with an example.

FIG. 3 is a series of images showing illuminance maps and clutter entropy levels for two workspace surfaces.

FIGS. 4a and 4b combine to form a first flowchart of a method for analyzing workspace desk clutter and generating improved layouts, in accordance with an example.

### DETAILED DESCRIPTION OF EMBODIMENTS

This present disclosure is directed to systems and methods for evaluating workspace surface clutter and generating improved workspace layouts. The system utilizes one or more sensors, such as thermopiles or spectrometers, to capture data and generate an illuminance map representing the current layout of objects on a user's workspace (such as a desk or table). The system then generates a clutter entropy level for the illuminance map. The clutter entropy level may be based on a determination of entropy level of the objects found on the workspace. If the clutter entropy level exceeds a clutter threshold, the system may provide the user with an indication that their workspace is too cluttered. The system may then generate, and provide to the user, decluttered layouts wherein the objects are rearranged to reduce clutter. The clutter indication and decluttered layouts may be provided to the user via a user interface. The system may train the clutter threshold and layout generator to user preferences based on feedback provided by the user and/or data captured by the sensors.

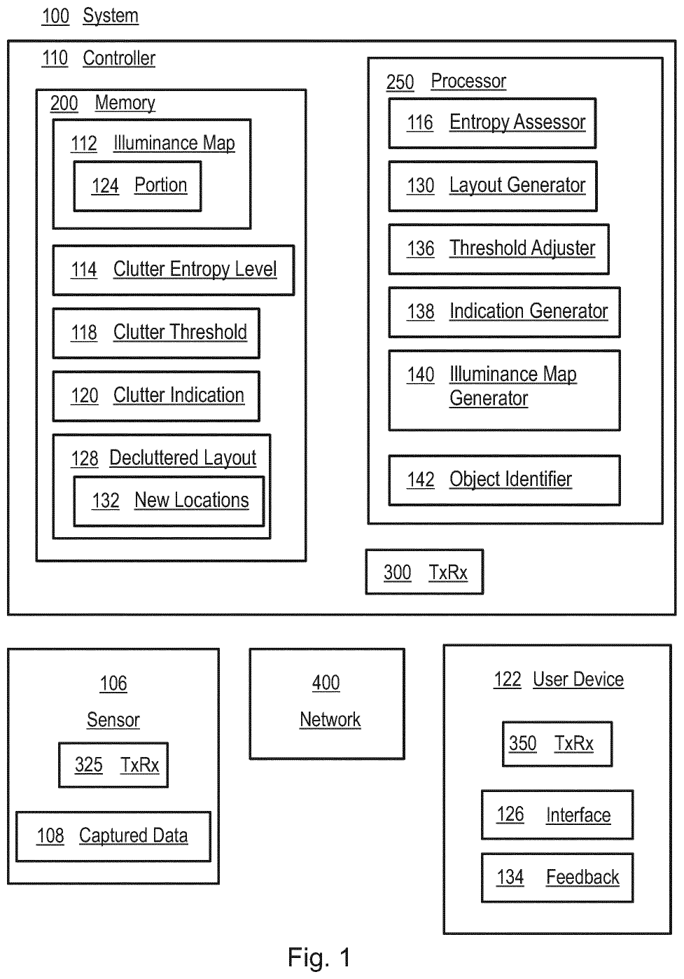

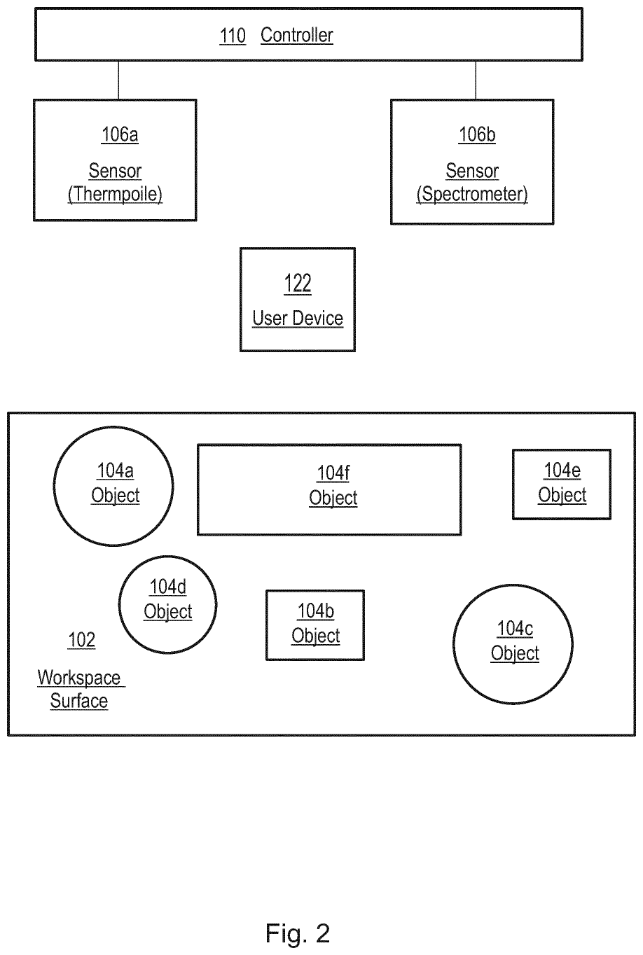

Referring to FIGS. 1 and 2, in one aspect, a system 100 for evaluating a workspace surface 102 is disclosed. The workspace surface 102 may be any flat surface upon which items may be placed. In one example, the workspace surface 102 may be a desk located in an office environment. In another example, the workspace surface 102 may be a tabletop, such as in a laboratory, a home office, an autobody shop, and the like.

As shown in FIG. 2, one or more objects 104 may be placed on the workspace surface 102. The objects may be any objects 104 which would be found on a workspace surface 102, such as, for example, computer desktops, computer laptops, computer peripherals (such as keyboards, mice, speakers, etc.), folders, books, writing utensils, table lamps, staplers, portable electronic devices (such as smartphones or tablets), etc. In other embodiments, the objects 104 may include tools, lab equipment, automotive parts, and/or other items that may be placed on a given workspace 102. In FIG. 2, for example, object 104a may be a computer speaker, object 104b may be a keyboard, object 104c may be a mousepad, object 104d may be a coffee mug, object 104e may be a laptop docking station, and object 104f may be a computer monitor. As described below, the system 100 may identify the ease of which certain objects 104 may be relocated on the workspace surface 102. For example, it may be easy for a user to relocate pens or folders, but it may be difficult to relocate a computer monitor.

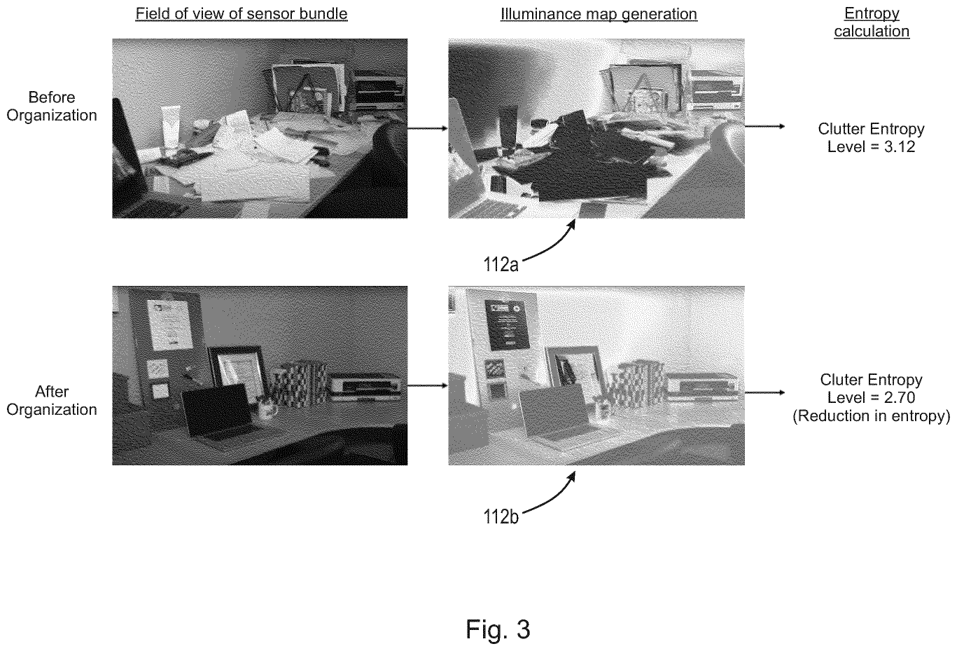

As shown in FIG. 2, the system 100 may include one or more sensors 106. The sensors 106 may be configured to capture data 108 corresponding to the workspace surface 102. In one example, and as shown in FIG. 2, at least one of the one or more sensors may be a thermopile 106a. In another example, as also shown in FIG. 2, at least one of the one or more sensors may be a spectrometer 106b. The one or more sensors 106 may include any other type of sensor capable of capturing data 108 representative of the clutter of the workspace surface 102. The sensors 106 may include multiple sensors 106 of a single type, such as multiple thermopiles. Further, the sensors 106 may include more than one type of sensor, such as, both a thermopile and a spectrometer. In a preferred embodiment, the sensors 106 may be positioned directly above the workspace surface 102. In a further example, the sensors 106 may be bundled together and attached to a luminaire. FIG. 3 shows example fields of view of the sensors 106. The illuminance maps generation and clutter entropy level calculation will be described herein. The sensors 106 may further include a transceiver 325 to wirelessly communicate with other components of the system 100 via network 400.

The system 100 may include a controller 110, one or more sensors 106, and a user device 122 capable of communication via a network 400. With reference to FIG. 1, the controller 110 may include a memory 200, a processor 250, and a transceiver 300. The memory 200 and processor 250 may be communicatively coupled via a bus to facilitate processing data stored in memory 200. Transceiver 300 may be used to transmit data to and/or receive data from a remote device, such as user device 122, via the network 400. The data received by the transceiver 300 may be stored in memory 200 and/or processed by processor 250. In an example, the transceiver 300 may facilitate a wireless connection between the controller 110 and the network 400.

The network 400 may be configured to facilitate communication between the controller 110, the sensors 106, the user device 122, and/or any combination thereof. The network 400 may be a wired and/or wireless network following communication protocols such as Bluetooth, Wi-Fi, Zigbee, and/or other appropriate communication protocols. In an example, the sensors 106 may wirelessly transmit, via the network 400, the captured data 108 to the controller 110 for storage in memory 200 and/or processing by the processor 250.

The controller 110 may be communicatively coupled to the one or more sensors 106 via the network 400. In one embodiment, the controller 110 includes a memory 200, a processor 250, and a transceiver 300. A communication bus may facilitate exchange of data between the memory 200, the processor 250 and the transceiver 300 within the controller 110. The memory 200 may be a computer readable medium as described herein. Additionally, the processor 250 may be capable of executing computer readable program instructions as described herein. The controller 110 may be configured to receive the captured data 108 from the sensors 106 via the network 400. The controller 110 may be further configured to store the captured data 108 in memory 200 before processing it as described herein.

The controller 110 may be configured to generate an illuminance map 112 of the workspace surface 102 via an illuminance map generator 140 executed by the processor 250. The illuminance map 112 may be generated based on the captured data 108. If the captured data 108 includes data of more than one mode (for example, captured data 108 from both thermopiles and spectrometers), the controller 110 may fuse the multiple modes of the captured data 108 via processor 250 into a coherent data set for illuminance map 112 generation.

In an example, the illuminance map 112 may be generated in grayscale. The grayscale illuminance map 112 may be an 8-bit image utilizing 256 gray levels. Example illuminance maps 112a and 112b are shown in FIG. 3. In FIG. 3, the illuminance map 112a of the “Before” workspace surface includes more numerous dark regions than the illuminance map 112b of the “After” workspace surface 102. Further, the dark regions of the “Before” workspace illuminance map 112a are significantly darker than the dark regions of the “After” workspace illuminance map 112b. The number and degree of these regions corresponds to the level of clutter 114 of the illuminance maps 112a and 112b. Referring to the “Before” workspace illuminance map 112a, the pile of objects in the middle of the workspace 102 (including papers, lotion bottle, eyeglass case, stapler, etc.) represent an area of a high degree of clutter, and is accordingly significantly darker in the illuminance map 112a than other portions of the workspace 102.

The controller 110 may be configured to generate a clutter entropy level 114 via an entropy assessor 116 executed by the processor 250. The clutter entropy level 114 represents the degree of overall clutter on the workspace surface 102. As demonstrated in FIG. 3, higher levels of clutter correspond to higher clutter entropy levels 114. In FIG. 3, the “Before” workspace has a clutter entropy level of 3.12, while the re-organized “After” workspace has a lower clutter entropy level of 2.70.

The clutter entropy level 114 may be generated based on the illuminance map 112. The processor 250 may execute the entropy assessor 116 to calculate the clutter entropy level 114 using the formula below:

clutter entropy level=Σᵢ₌₀ⁿ⁻¹pᵢ log_{b}pᵢ (1)

where n is the number of gray levels in the illuminance map (such as 256 for an 8-bit image), pᵢ is the probability of a pixel of the illuminance map having a gray level i, and b is the base of the logarithmic function.

The system 100 may further include a user device 122. The user device 122 may include a display configured to render a user interface 126 including the clutter entropy level 114. The user device 122 may be a smartphone or similar device. In an example, the user interface 126 may include a display built into a smartphone or similar mobile device. The user device 122 may be communicatively coupled to the controller 110 via wired connection facilitated by transceiver 350 via the network 400. The user device 122 and user interface 126 may include various additional input and output features and mechanisms.

The controller 110 may be configured to determine, via indication generator 138 executed by processor 250, whether the clutter entropy level 114 exceeds a clutter threshold 118. The clutter threshold 118 may be set by the user, such as via user interface 126, prior to analysis. In a further example, the clutter threshold 118 may be set according to previously collected clutter entropy levels 114 corresponding to captured data 108 of previous workspace layouts.

The controller 110 may be configured to provide a clutter indication 120 to the user device 122 associated with the workspace surface 102 if the clutter entropy level 114 exceeds the clutter threshold 118. The clutter indication 120 may be generated by the indication generator 138 executed by the processor 250. The indication generator 138 may be further configured to generate a clutter indication 120 if the clutter entropy level 114 exceeds the clutter threshold 118. The clutter indication 120 may be displayed via the user interface 126, such as, for example, a message on a display screen. In a further example where the controller 110 is in communication with a luminaire housing the sensors 106, the controller 110 may trigger the luminaire to blink, darken, brighten, change color, or otherwise behave to notify the user of the workspace 102 exceeding the clutter threshold 118.

The controller 110 may be further configured to identify, via an object identifier 142 executed by the processor 250, one or more of the objects 104 placed on the workspace surface 102 corresponding to at least a portion 124 of the illuminance map 112. In one example, the controller 110 simply identifies the objects 104 as discrete items for re-arranging. In further examples, controller 110 may identify the objects 104 as different types of items, such as papers, computer peripherals, etc. This classification can be utilized by the layout generation aspect of the system 100.

The controller 110 may be further configured to generate a decluttered layout 128 based on the one or more objects 104 via a layout generator 130 executed by the processor 250. The decluttered layout 128 may include proposed new locations 132 for the one or more objects 104 placed on the workspace surface 102. The layout generator 130 may be used to create a plurality of arrangements of the objects 104, determine which has the lowest entropy level based on the above clutter entropy level equation, and designate that arrangement as the decluttered layout 128. In generating the decluttered layout 128, the layout generator 130 may also factor in the user's history regarding previously adopted or rejected layouts, whether the user modified the previously suggested layouts, as well as arrangement restrictions for certain objects 104. For example, an object 104 classified as a computer monitor may be left in place, while an object 104 classified as a legal pad may be re-arranged freely about the workspace surface 102. In this instance, the layout generator 130 may propose a decluttered layout 128 that suggests a location for the legal pad in accordance with user preference rather than the entropy of the layout.

The controller 110 may be further configured to provide the decluttered layout 128 to the user device 122 via network 400. In further examples, the controller 110 may provide a series of decluttered layouts 128 to the user device 122 with various combinations of object 104 arrangements and clutter entropy levels 114.

According to an example, the processor 250 may execute the layout generator 130 to generate the series of decluttered layouts 128 by first generating a series of prospective layouts for the objects 104. These prospective layouts are generated by moving the various objects 104 around the workspace surface 102. In this example, the objects 104 are not classified in terms of object type (such as computer monitor, keyboard, legal pad, etc.). Rather, the layout generator 130 may simply try a number of different arrangements of objects 104. The layout generator 130 may be configured to avoid certain prospective layouts based on user preferences regarding previously rejected or ignored decluttered layouts 128. The entropy level of each prospective layout is then determined, and the prospective layouts with the lowest entropy levels are shortlisted. The shortlisted layouts may then be ranked or weighted based on user preferences regarding previously used decluttered layouts 128. The user preferences may have been explicitly provided by the user via, for example, the user device 122, or they may have been determined implicitly by monitoring the workspace surface 102. The ranked shortlisted layouts may then be provided to the user as the series of decluttered layouts 128 via the user device 122.

According to an example, the one or more decluttered layouts 128 may be sent over the network 400 to the user device 122 to be rendered on the user interface 126 associated with the user device 122. Further, the user interface 126 of the user device 122 may be additionally configured to receive user feedback 134 regarding the decluttered layout 128. The user device 122 may then be configured to provide the user feedback 134 to the controller 110. In an example, the user may be able to use a button or keyboard to approve or reject a provided decluttered layout 128. This approval or disapproval may be used by the controller 110 to train the layout generator 130 so that future decluttered layouts 128 adopt certain characteristics of the approved layouts and avoid certain characteristics of the rejected layouts. Similarly, according to an example, the controller 110 may be further configured to update the clutter threshold 118 based on the user feedback 134 and a threshold adjuster 136. For example, if the user rejects a provided decluttered layout 128, the threshold adjuster 136 may increase the value of the clutter threshold 118.

According to an example, the controller 110 may be further configured to update the clutter threshold 118 based on the captured data 108 corresponding to the workspace surface 102 via a threshold adjuster 136 executed by the processor 250. For example, if the captured data 108 shows that the user has not re-arranged their workspace 102 to match the provided decluttered layout 128, the threshold adjuster 136 may increase the value of the clutter threshold 118. Similarly, the controller 110 may be further configured to update the layout generator 130 based on the captured data 108 corresponding to the workspace surface 102. For example, if the data 108 captured subsequent to the provision of the decluttered layout 128 shows that the user has not re-arranged their desk to match the provided decluttered layout 128, the controller 110 may train the layout generator 130 so that future decluttered layouts 128 adopt certain characteristics of the approved layouts and avoid certain characteristics of the rejected layouts. Accordingly, a user continually leaving their desk arrangement in place despite being provided improved layouts may be an indication that the clutter threshold 118 has been set far too low. By tracking the rejection of the decluttered layouts 128, the system 100 can train the clutter threshold 118 to a level appropriate for the user.

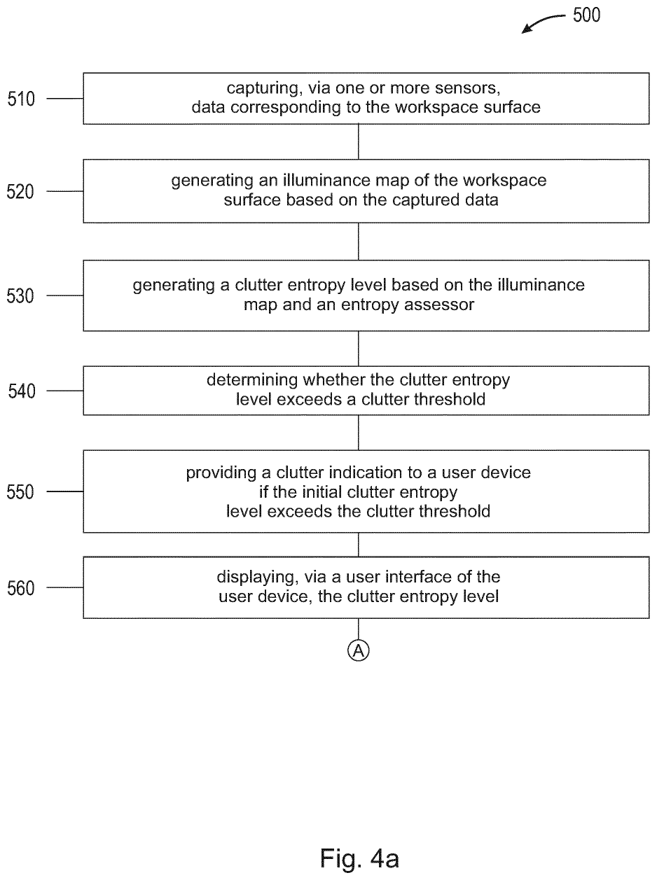

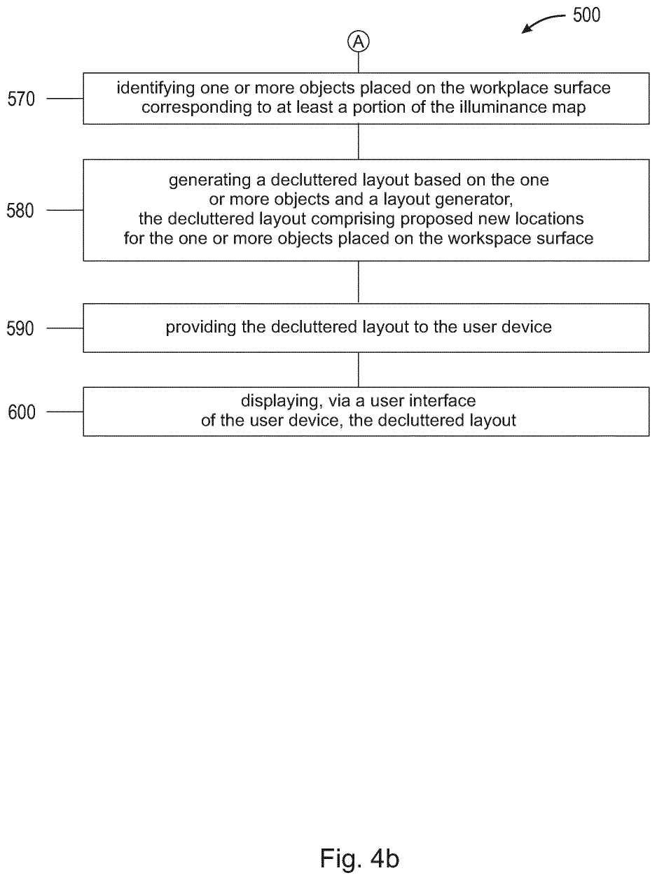

Referring to FIG. 4a, a method 500 for evaluating a workspace surface having one or more objects placed thereon is disclosed. The method may include capturing 510, via one or more sensors, data corresponding to the workspace surface. The method may further include generating 520 an illuminance map of the workspace surface based on the captured data. The method may further include generating 530 a clutter entropy level based on the illuminance map and an entropy assessor. The method may further include determining 540 whether the clutter entropy level exceeds a clutter threshold. The method may further include providing 550 a clutter indication to a user device associated with the workspace surface if the clutter entropy level exceeds the clutter threshold. The method 500 may further include displaying 560, via a user interface of the user device, the clutter entropy level.

Referring to FIG. 4b, the method 500 may further include identifying 570 one or more objects placed on the workspace surface corresponding to at least a portion of the illuminance map. The method may further include generating 580 a decluttered layout based on the one or more objects and a layout generator, the decluttered layout including proposed new locations for the one or more objects placed on the workspace surface. The method may further include providing 590 the decluttered layout to the user device. The method 500 may further include displaying 600, via a user interface of the user device, the decluttered layout.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of,” or “exactly one of”.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A system for evaluating a workspace surface having one or more objects placed thereon, comprising:
one or more sensors configured to capture data corresponding to the workspace surface;
a controller communicatively coupled to the one or more sensors, the controller configured to:
generate an illuminance map of the workspace surface based on the captured data;
generate a clutter entropy level based on the illuminance map;
wherein clutter entropy level represents the degree of overall clutter on the workspace surface;
determine whether the clutter entropy level 14 exceeds a clutter threshold; and provide a clutter indication to a user device if the clutter entropy level exceeds the clutter threshold
characterized in that the controller is further configured to:
identify one or more of the objects placed on the workspace surface corresponding to at least a portion of the illuminance map;
generate a decluttered layout based on the one or more objects and a layout generator, the decluttered layout comprising proposed new locations for the one or more objects placed on the workspace surface; and
provide the decluttered layout to the user device.

2. (canceled)

3. (canceled)

4. The system of claim 1, further comprising a user interface configured to receive user feedback regarding the decluttered layout.

5. The system of claim 4, wherein the controller is further configured to update the clutter threshold based on the user feedback and a threshold adjuster.

6. The system of claim 1, wherein the controller further configured to update the clutter threshold based on the captured data corresponding to the workspace surface and a threshold adjuster.

7. The system of claim 1, wherein the controller is further configured to update the layout generator based on the captured data corresponding to the workspace surface.

8. The system of claim 1, wherein at least one of the one or more sensors is a thermopile.

9. The system of claim 1, wherein at least one of the one or more sensors is a spectrometer.

10. The system of claim 1, wherein the illuminance map is generated in grayscale.

11. A method for evaluating a workspace surface having one or more objects placed thereon, comprising:
capturing, via one or more sensors, data corresponding to the workspace surface;
generating an illuminance map of the workspace surface based on the captured data;
generating a clutter entropy level based on the illuminance map; wherein clutter entropy level represents the degree of overall clutter on the workspace surface;
determining whether the clutter entropy level exceeds a clutter threshold; and
providing a clutter indication to a user device if the clutter entropy level exceeds the clutter threshold
characterized in that further comprising:
identifying one or more objects placed on the workspace surface corresponding to at least a portion of the illuminance map;
generating a decluttered layout based on the one or more objects and a layout generator, the decluttered layout comprising proposed new locations for the one or more objects placed on the workspace surface; and
providing the decluttered layout to the user device.

12. The method of claim 11, further comprising displaying via a user interface of the user device, the clutter entropy level.

13. The method of claim 11, further comprising displaying via a user interface of the user device, the decluttered layout.
